(19) United States
(12) Patent Application Publication
(10) Pub. No.: US 2009/0126948 A1
(43) Pub. Date: May 21, 2009

(54) Use of rhamnolipid-based formulations for fire suppression and chemical and biological hazards

(76) Inventor: Keith DeSanto, St. Petersburg, FL (US)

Correspondence Address: DEFILLO & ASSOCIATES, INC., P.O. Box 14104, Clearwater, FL, 33766, US

(21) Appl. No.: 11/985,977

(22) Filed: Nov. 19, 2007

(51) Int. Cl. A62D 1/02; A62D 1/00; C09D 5/00; B05D 1/00; B05D 5/00; A62C 3/00; A62B 17/00

(52) U.S. Cl. 169/45; 252/2; 252/601; 252/3; 106/12; 427/11; 2/81

(57) ABSTRACT

The present invention relates to rhamnolipid-based formulations for bio-hazard coatings and fire extinguishing compositions. In addition, the present invention relates to the methods of extinguishing fires and protecting objects by using the formulations of the present invention.

### FIELD OF THE INVENTION

The present invention relates to rhamnolipid based formulations. More specifically, it relates to formulations containing rhamnolipids for chemical and/or bio-hazard coatings and fire suppressant compositions.

### BACKGROUND OF THE INVENTION

Surfactants are chemicals that reduce the surface tension of water. A surfactant is made up of two parts, a head and a tail, each part exhibits differing properties: the head is hydrophilic (it is attracted to water), while the tail is hydrophobic (it tends to distance itself from water). Because of these characteristics, a surfactant exhibits a unique reaction when in contact with water, reducing the surface tension of water.

It is well known in the prior art that surfactants are used in the manufacture of soaps, laundry detergents, dishwashing liquids, personal care products, lubricants, emulsion polymerization, textile processing, mining flocculates, petroleum recovery, and wastewater treatment.

The majority of the surfactants used by the prior art are derived from petroleum sources. These chemical surfactants pose significant environmental risks because they form harmful compounds from incomplete bio-degradation in water or soil.

In recent years, the prior art is showing an increase in the use of bio-surfactants, because they are an environmentally friendly alternative to petroleum-derived surfactants and their potential use in different areas, such as the food industry, agriculture, pharmaceuticals, cosmetic, and oil industries.

Rhamnolipid bio-surfactant, secreted from Pseudomonas Aeruginosa, is a naturally occurring extracellular glycolipid that is found in the soil and on plants. Rhamnolipids are powerful bio-surfactants that provide a great antibacterial and antifungal activity, and low toxicity levels, which make them an attractive alternative to the known petroleum derived surfactant used in the pharmaceutical industry, the petroleum industry, agriculture, personal care products, animal cleaning products, and other applications.

In previous patents/applications owned by the present assignee, rhamnolipids have been used basically in the medical field to combat certain types of bacteria, viruses, and fungi.

The present inventor is continually studying the characteristic of rhamnolipids in order to expand their use into new fields.

Applicant notes that fires have increased in incidence in the recent past. Fire is a continuing danger to life and property worldwide. In rural areas forest, brush, and grassland fires cause immense damage each year. This destruction is not only in terms of the dollar value of timber, wildlife and livestock, but the catastrophic effects on erosion, watershed equilibrium and related problems to the natural environment.

To combat wild forest fire, water bombers and helicopters with water buckets are commonly used to dispense water on fires. The increased surface area of water exposed to the superheated air results in a significant increase in the rate of evaporation and the aqueous material tends to form a mist, which drifts away from the intended target area.

Over the years man has found numerous ways to overcome the above-identified problem.

The prior art uses potassium carbonate and potassium hydrogen carbonate aqueous solutions as aqueous fire extinguishing agents. Such fire extinguishing agents extinguish fire with cooling and moisture (wetting)-permeability effects of water. They effectively prevent re-start of fire and provide a clear view to an operator during fire extinguishing. However, numerous problems have been encountered in using the above-identified existing fire extinguishing agents. Although the composition of such aqueous fire extinguishing agents excellently extinguish fire, the above aqueous fire foams are strongly alkaline; thus, it is a concern on the environmental impact of the existence fire extinguishing has on humans, animals, or vegetation.

Similar problems are experienced when spraying or jetting water onto fires with handheld fire extinguishers. The water stream breaks into fine droplets over distance which limits the distance it can travel and increases the loss to evaporation.

Accordingly, there is a need to provide a safe and acceptable fire extinguishing composition that is both environmentally and toxicologically friendly, thereby avoiding the above disadvantages.

Furthermore, the present inventor focused his attention on the problems presented by the need for innovative methods to protect individuals from direct and/or secondary contact with dangerous materials capable of spreading infectious diseases (such as laboratory spills, human blood, body fluids, body tissue, contaminated dressings and contaminated clothing and equipment).

This need has grown in direct proportion to the public's increased awareness and concern that terrorists are capable of launching a major biological attack on civilian populations. They might use localized bio-hazardous material, such as weaponized anthrax, or they might use deadly infectious agents, such as smallpox. Numerous such materials and agents exist, each with its own transmission efficiency, survivability in the atmosphere, portability, resulting symptoms, resulting morbidity and resulting mortality.

The present inventor thought of the necessity of finding a solution to the above-identified problem by providing a composition that offers bio-hazard protection, cleaning abilities, along with antibacterial capabilities, while at the same time is non-toxic, biodegradable, and environmentally friendly.

### SUMMARY OF THE INVENTION

It is an objective of the present invention to provide a fire extinguishing composition that can be effectively applied using ground spray equipment, a helicopter or airplane, or other means known to fire fighters.

It is another objective of the present invention to provide a safe and acceptable fire extinguishing composition that is both environmentally and toxicologically friendly.

It is another objective of the present invention to provide a non-corrosive fire extinguishing composition that can be carried by aircraft to the site of the fire.

It is another objective of the present invention to provide a composition that offers bio-hazard protection, cleaning abilities, along with antibacterial capabilities, while at the same time is non-toxic, biodegradable, and environmentally friendly.

After intense research and development, the present inventor discovered that rhamnolipids can be used along with water or other liquids to enhance man's ability to extinguish fires without damaging the environment. In addition, the present inventor discovered that rhamnolipids can be mixed with other material to create a protective coating in protective apparel, tools, appliances, rooms, bandages, wraps, gauze, in order to prevent bio-hazard contamination.

The fire extinguishing formulation according to the present invention comprises:
0.01% to 35% volume of rhamnolipid; and
the balance being water as a carrier.
preferably 0.75% to 35% of rhamnolipid.

In another preferable embodiment, the carrier is an existing fire extinguishing formulation.

The present invention also contemplates a method for preventing, retarding, suppressing, and extinguishing fires comprising the steps of:

applying a sufficient amount of the fire extinguishing formulation of the present invention to the area to be treated;

wherein the formulation is applied either before or after initiation of combustion.

In another preferable embodiment, the present invention further includes a colorant.

In one preferable embodiment of the present invention the rhamnolipid is a crude or partial purified rhamnolipid containing a mono-rhamnolipid and a di-rhamnolipid, or mixture of both. In another embodiment, the present invention contemplates the use of highly purified rhamnolipids.

In another preferable embodiment, the rhamnolipid is incorporated into an existing fire extinguishing or retardant formulation.

Rhamnolipids create a barrier when applied to any type of surface, preventing the growth of bacteria and fungus. This technique is especially useful to create clean surface areas for medical procedures and equipment, chemical testing equipment, food preparation processes and equipment, daycare centers and hospital facilities, military vehicles and equipment, bandages and other wound care appliances.

The formulations of the present invention present good antibacterial, antifungal, emulsification, wetting, detergency, and foaming properties, along with low toxicity. They are environmentally friendly and do not produce any harmful degradation products.

In another aspect of the present invention, it is contemplated as a method for coating an object with a formulation including rhamnolipids to protect the object from fire and chemical or bio-hazards contamination.

The coating forming formulation according to the present invention comprises:
0.01% to 35% volume of rhamnolipid; and
the balance being water as a carrier.
preferably 0.75% to 35% of rhamnolipid.

Suitable products for coating include, but are not limited to, fibers, fabrics, films, non-woven fabrics, woven fabrics, yarn, knitted fabrics, garments, protective clothing, scrubs, coveralls, booties, face masks, gloves, apparel, linens, drapes, towels, laminates containing at least one fabric or film, sponges, mop heads, webs, bags, gauze, pads, wipes, pillows, bandages, or a combination thereof. In one desired embodiment of the present invention, the product comprises one or more pieces of protective garment, such as scrubs, coveralls, protective suits, booties, face masks, and gloves, bio-hazard suits. In addition, the suitable product for coating includes medical equipment, chemical laboratory equipment, food preparation equipment, daycare centers and hospital equipment and walls, military vehicles and equipment, bandages, gauze, wraps, and first aid appliances.

The formulation may be in the form of a liquid, foam, aerosol, powder, mist, gel, film, solid, or spray.

Furthermore, the present invention relates the incorporation of rhamnolipids into articles including yarn, fabrics, bandages, gauze, wraps, and equipment to provide protection against life threatening hazards, such as chemicals agents, biological agents, and fire. In some embodiments, the yarn or fabric are impregnated with the composition of the present invention prior to producing the fabric. The, the fabrics having the rhamnolipids incorporated are used to produce garments with multiple hazard protection and superior heat dissipating properties.

In another embodiment, the protective apparel and/or equipment is impregnated with the rhamnolipid formulation after the object is finished. In another embodiment, a layer of the composition of the present invention is applied to the inside the protective garment during the manufacture of the garment.

### DETAILED DESCRIPTION OF THE INVENTION

The present invention provides a way to effectively and economically provide protection against multiple types of hazards. The type of hazards are selected, but not limited to, fire, biological, and chemical hazard.

Effective amount” means the amount of the rhamnolipid that as a whole, provides an antimicrobial (including, for example, antiviral, antibacterial, or antifungal) activity that reduces, prevents, or eliminates one or more species of microbes, such that an acceptable level of the microbe results. Typically, this is a level that may be low enough not to cause clinical symptoms, and is desirably a non-detectable level.

The fire fighting composition herein described is to be used through standard firefighting equipment and applied to the fire.

Extinguishment is typically achieved by the initial discharge of the fire extinguishing formulation, while re-ignition is prevented by reducing the volatility of the fuel. This is typically accomplished by using suppressants that can cool the fire, e.g., water. According to the invention, reduced volatility can also be affected using wetting and/or foam-forming additives that form a layer on the fuel surface and inhibit fuel vaporization.

The fire extinguishing formulation according to the present invention comprises:
0.01% to 35% volume of rhamnolipid; and
the balance being water as a carrier.
Preferably 0.75% to 35% of rhamnolipid.

The formulation of the present invention may further comprise one or more of additional ingredients. These include, for example, wetting agents, cooling agents, dispersing agents, suspending agents, antifoaming agents, de-foaming agents, preservatives, stabilizing agents, a pH buffer, binding agents, thickening agents and any mixture thereof.

### Rhamnolipid

The formulations of the invention comprise of one or more rhamnolipids. These rhamnolipids includes mono-rhamnolipid, a di-rhamnolipid, or a combination of the two.

The formulations of the present invention may use crude or highly purified rhamnolipids. A crude rhamnolipid is a rhamnolipid, having many impurities both external impurities, and/or a variety of various rhamnolipid mixtures, which causes a reduced effect on the formulation. Highly purified rhamnolipids is a rhamnolipid whose external impurities have been removed, and/or the rhamnolipids have been purified to meet certain parameters to cause an increased effect on the formulation which includes di-rhamnolipid, mono-rhamnolipid or a certain mixture of both.

After long experimentation, and in contrast to the rhamnolipid formulations known in the art, the present inventor discovered that crude rhamnolipids in the form readily available in the marketplace, and further refined or purified, can be used in certain formulations of the present invention, while highly purified rhamnolipids are required for certain other formulations.

The formulations are made by eliminating unwanted impurities from the initial mixture and then establishing the percentage and type of rhamnolipid to be present in the final mixture and simply diluting the rhamnolipid preparation with a carrier or diluents, preferably water The present invention is not limited by the use of water as carrier or diluent. The present invention contemplates the use of any carrier or diluents, as long as it is compatible with rhamnolipid.

In general, the rhamnolipid preparation (“crude” or partially purified therefrom) is diluted to a final concentration of less than 70%. In various embodiments of the invention, the final formulations contain in the range of about 0.25% to about 70% rhamnolipid preparation, with preferred formulations being about 50%, or about 35%, or less of the rhamnolipid preparation in the final formulation depending upon the end use application.

In the present invention the use of the term “rhamnolipid” implies indistinctively crude or highly purified rhamnolipids, and various mixtures of the rhamnolipid components.

Rhamnolipids are generally secreted from Pseudomonas aeruginosa, though there are other bacteria that also create Rhamnolipids. Typically, the bacterium Pseudomonas aeruginosa is cultured in a suitable medium and grown to a desired density. The bacteria themselves are removed from the culture media by any method known in the art, such as centrifugation. The supernatant may be used directly as the crude preparation, or further processing steps well-known to those of skill in the art may be carried out (e.g. concentration, filtration, column chromatography, and the like). Notably, however, the final rhamnolipid preparation is not highly purified and is referred to as “crude rhamnolipid”, and typically contains a mixture of both mono-rhamnolipids and di-rhamnolipids, and other compounds. Those of skill in the art will recognize that the precise details of cultivation and partial purification may vary somewhat and still be within the scope of the invention.

Preparation of Crude Rhamnolipid Preparations and highly purified rhamnolipid preparations may be prepared by methods that are well-known to those of skill in the art.

In one preferable embodiment of the present invention the rhamnolipid is a crude or partial purified rhamnolipid containing a mono-rhamnolipid and a di-rhamnolipid, or mixture of both. In another embodiment, the present invention contemplates the use of highly purified rhamnolipids.

### Wetting Agents

Normally, wetting agents in aqueous solution decrease the surface tension to about 0.00025 to 0.00027 N/cm (or 25-27 nM/m). Rhamnolipids are natural wetting agents, thus, adding additional wetting agents to the formulation including rhamnolipids produces synergistic effects that reduces even more the surface tension of the water.

Examples of wetting agents that are suitable for use in the present invention include, but are not limited to, free acids or organic phosphate esters or the dioctyl ester of sodium sulfosuccinic acid, polyoxyethylene (POE) alkyl ethers, preferably NP-6 (Nonylphenol ethoxylate, 6 ethyleneoxide units) such as DisperByk® 101.

### Cooling Agent

A cooling agent was added to water to enhance the cooling effect of the water. Water functions in most fire fighting applications as a coolant. However, the heat capacity of water can be increased and its cooling capacity increased by the addition of a cooling compound.

Examples of cooling agent that are suitable for use in the present invention include, but are not limited to, ethylene glycol, propylene glycol, polypropylene glycol, organic alcohols having C=8 or greater, or salts, including potassium acetate, calcium chloride, potassium lactate and ammonium acetate.

### Dispersing Agents, Suspending Agents, and Thickening Agents

Examples of dispersing agents and/or suspending agents and/or thickening agents that are suitable for use in the present invention include, but are not limited to, acrylic acids, acrylic acids ester copolymer neutralized sodium polycarboxyl such as naphthalene sulfonic acid-formaldehyde condensate sodium salt, alginates, cellulose derivatives and xanthan.

Defoaming and/or Antifoaming

Examples of defoaming and/or antifoaming agents that are suitable for use in the present invention, include, but are not limited to, mineral oil emulsions, natural oil emulsions, and preferably are silicon oil emulsions, such as AF-52.TM.

### Others

Examples of preserving or stabilizing agents that are suitable for use in the present invention, include, but are not limited to, formaldehyde, alkyl hydroxy benzoates, methyl and propyl hydroxy benzoates, and mixture thereof.

### Emollients

A wide variety of emollients are appropriate for inclusion in this invention. Among them are those listed here, which are set forth by way of example and not by way of limitation. Among those which can be used within this invention are: glycerine; propylene glycol; sucrose distearate; tocopherol; polyethylene glycol succinate; oil of egg; wheat germ oil; lanolin alcohol; ethoxylated lanolin; isopropyl palmitate; ethoxylated sterol; ethoxylated glucose derivative; polyoxylated glucose derivative; isopropyl stearate and non-linear alcohols having about C=7 to about C=28, alkoxylated lanolin; PEG 15-50 hydrogenated lanolin; PPG 15-50 hydrogenated lanolin; calcium stearoyl lactylate; cetyl octanoate; myreth-3 laurate; PEG 5 to 25 caprylic glyceride; PPG 5-25 capric glyceride; PPG 5-25 caprylic glyceride; PPG 5-25 capric glyceride; polyoxyethylene cholesterol (15-35 E.O; ethoxylated glycol; sucrose cocoate and cetyl alcohol.

### Colorants

In a preferable embodiment, the present invention further includes a colorant. The colorant must fade over time and under ambient field conditions to a colorless or less highly colored hue. A number of such dyes and pigments are well known in the art. Typical examples of prior art colorant are C.I. Basic Red I dye, 6BL dye, Basic Violet II dye, Basic Yellow 40 and encapsulated-dye pigments which are available commercially, e.g., the “AX” series pigments, supplied by Day-Glo Color Corp., Cleveland, Ohio.

Each of the succeeding Examples is formulated using water as a carrier. Water is the most preferred carrier. Other carriers may be employed, but water has the advantage of being an appropriate agent for a wide variety of fires and is applicable to a wide range of fuels for purposes of controlling the flammability or for extinguishing flame. The effect of water as a coolant, to reduce the temperature of the fuel is enhanced by incorporation of coolants, as was previously disclosed. In addition, the reactivity of water with certain materials can be adjusted through the addition of additives to effect an increase or decrease in the cooling capacity of water, to increase or decrease the miscibility of water with a variety of materials.

The cooling effect of water acts to reduce the temperature of the burning material below the flash or ignition point. This results in a reduction of burning capability.

The present invention also contemplates a method for preventing, retarding, suppressing, and extinguishing fires comprising the steps of:

applying a sufficient amount of the fire extinguishing formulation of the present invention to the area to be treated;

wherein the formulation is applied either before or after initiation of combustion.

In another preferable embodiment, the rhamnolipid is incorporated into an existing fire extinguishing or retardant formulation.

The fire extinguished composition of the present invention has unique characteristics because:

it is able to extend the area of coverage by preventing the formation of mist;

provides a slow solution drainage, thus substantially preventing the run-off of the fire extinguishing formulation from the immediate environment of the fire;

increases humidity, cooling and solution penetration of the forest floor and canopy through wetting.

Thus, evaporation is suppressed and a wetter environment is maintained so as to substantially prevent the fire from starting again or spreading to the area which has been sprayed.

Preferably, for ground fire fighting applications, the compositions of this invention are used at about 4% to 35% rhamnolipids in the solution by volume concentration. However, for both ground and aerial fire fighting, the composition may be mixed with an inert carrier such as sea water or fresh water at a concentration of from about 10% to 35% by volume.

In general, the present fire extinguishing formulation contains rhamnolipids in an amount such that sufficient free water is present to provide an excellent fire extinguishing effect with minimal damage caused by water, and to allow its application while ensuring a very good wetting capacity, analogous to that of pure water.

### EXAMPLE 1

Wood was used as the combustible material. Forty pounds of wood was treated with gasoline and ignited. It was allowed to burn for ten minutes before extinguishment. Plain water was used to extinguish the wood. It took the Applicant 120 seconds to extinguish the fire.

A second pile of forty pounds of wood was similarly ignited and allowed to burn ten minutes. A formulation comprising 15% volume of rhamnolipid and the balance water was used to extinguish the fire. It took the Applicant 30 seconds to extinguish the fire.

A fruity smell was perceived on the area where the fire was set up. The inventor observed a pearl color coating covering the burned wood.

### EXAMPLE 2

A pile of eighty pounds of wood was similarly ignited and allowed to burn ten minutes. A formulation comprising 5% volume of rhamnolipid and the balance water was used to extinguish the fire. It took the Applicant 30 seconds to extinguish the fire.

A fruity smell was perceived on the area where the fire was set up. The inventor observed a pearl color coating covering the burned wood.

Film Form Protecting Against Fire Hazard and Biological and/or Chemical Contamination

After further research, the inventor discovered that rhamnolipids create a barrier (film) when applied to any type of surface, preventing the growth of bacteria and fungus. This technique is especially useful to create clean surface areas for medical procedures and equipment, chemical testing equipment, food preparation processes and equipment, daycare centers and hospital facilities, military vehicles and equipment, bandages and other wound care appliances.

The formulations of the present invention present good antibacterial, antifungal, emulsification, wetting, detergency, and foaming properties, along with low toxicity. They are environmentally friendly and do not produce any harmful degradation products.

In view of the above, the present inventor thought of a method for coating an object with a formulation including rhamnolipids to protect the object from fire, chemical, or bio-hazards contamination.

Furthermore, the present inventor thought of the idea of incorporating rhamnolipids into articles including yarn, fabrics, bandages, gauze, wraps, and equipment to provide protection against life threatening hazards, such as chemicals agents, biological agents, and fire. In some embodiments, the yarns or fabrics are impregnated with the composition of the present invention prior to producing the fabric. The, the fabrics having the rhamnolipids incorporated are used to produce garments with multiple hazard protection and superior heat dissipating properties.

In the context of this disclosure, a number of terms shall be utilized.

The term “film” as used herein means a thin but discrete structure that moderates the transport of species in contact with it, such as gas, vapor, aerosol, liquid and/or particulates. Films are generally understood to be less than about 0.25 mm thick.

Unless otherwise stated or apparent by the particular context, the term “rhamnolipid” implies indistinctively crude or highly purified rhamnolipids, and various mixtures of the rhamnolipid components.

The term “rhamnolipid coating” as used herein means a film that contains a formulation having at least one rhamnolipid in the amount of at least 0.75% by volume.

The term “object” as used herein means but are not limited to, fibers, fabrics, films, non-woven fabrics, woven fabrics, yarn, strings, knitted fabrics, garments, protective clothing, scrubs, coveralls, booties, face masks, gloves, apparel, linens, drapes, towels, laminates containing at least one fabric or film, sponges, mop heads, webs, bags, gauze, pads, wipes, pillows, bandages, or a combination thereof. In one desired embodiment of the present invention, the product comprises one or more pieces of protective garment, such as scrubs, coveralls, protective suits, booties, face masks, and gloves, bio-hazard suits. In addition, the suitable product for coating includes medical equipment, chemical laboratory equipment, food preparation equipment, daycare centers and hospital equipment and walls, military vehicles and equipment, bandages, gauze, wraps, and first aid appliances.

The coating composition to protect against exposure to a chemical, fire, or biological agents according to the present invention comprises:
0.01% to 65% of rhamnolipid;
Up to 3% of a wetting agent;
Up to about 10% of a permeation agent; and
the balance being water,
preferably 0.75% to 65% of rhamnolipid.

In other embodiments, the invention provides methods of inhibiting the permeation of a chemically or biologically harmful agent through an article or item of apparel fabricated therefrom, by including within the selectively permeable laminate a continuous rhamnolipid film.

In further embodiments the invention provides methods of fabricating a coating (film) that protects against exposure to a chemical, fire, or biological agent that is harmful to human health, and methods of fabricating items of apparel, by incorporating into a structure or item of apparel a layer comprising the rhamnolipid based coating formulation according to this embodiment.

Methods available to coat surfaces include without limitation spray coating, dip coating, spin coating, reverse roll, wire-wound or Mayer rod, direct and offset gravure, slot die, blade, hot melt, curtain, knife over roll, extrusion, air knife, rotary screen, multilayer slide, co-extrusion, meniscus, comma and microgravure coating. The method chosen will depend on the desired wet film thickness, the speed of a substrate that is traveling, and the required coating accuracy as a percent of total thickness.

The applied composition is then dried by any suitable means known in the art such as exposure to a hot air oven, air impingement drying, or radiative (e.g. infrared or microwave) drying.

The result of the drying at this stage is a continuous film.

If a film at this stage is water-soluble, it can be made water-insoluble by heating; by reacting it with a crosslinking reagent; by treatment with a strong base; or by a combination of two or more of these methods.

The film can also be made insoluble by adding any of a variety of crosslinking agents to a solution before a film is cast therefrom. A crosslinking agent is a reactive additive that creates bonds, i.e. crosslinks, between polymer chains. Examples of crosslinking agents include without limitation glutaraldehyde, epichlorohydrin), and di-, and tri-carboxylic acids including succinic, malic, tartaric, and citric acids.

Suitable objects for coating include, but are not limited to, fibers, fabrics, films, non-woven fabrics, woven fabrics, yarn, knitted fabrics, garments, protective clothing, scrubs, coveralls, booties, face masks, gloves, apparel, linens, drapes, towels, laminates containing at least one fabric or film, sponges, mop heads, webs, bags, gauze, pads, wipes, pillows, bandages, or a combination thereof. In one desired embodiment of the present invention, the product comprises one or more pieces of protective garment, such as scrubs, coveralls, protective suits, booties, face masks, and gloves, bio-hazard suits. In addition, the suitable product for coating includes medical equipment, chemical laboratory equipment, food preparation equipment, daycare centers and hospital equipment and walls, military vehicles and equipment, bandages, gauze, wraps, and first aid appliances.

The barrier coating provided by the compositions described herein may be visibly present on the cleaned surfaces as a semi-translucent film. Providing such a film on the surfaces goes against conventional wisdom in that the surfaces do not appear perfectly clean. However, this film is effective to deliver active components to the surface of the equipment making attachment of contaminants to the surface much more difficult.

### Solvent

A major component of the solutions described herein is an aqueous solvent, such as water. The compositions described herein typically contain a major amount of the solvent which may be provided by potable water.

### Permeation Agent

Permeation agents are effective to penetrate the coating film to the object surface interface. Suitable permeation agents may be may be used, include but are not limited to, sodium coconut alkyl sulfate, potassium coconut alkyl sulfate, potassium lauryl sulfate, sodium lauryl sulfate, sodium yellow fatty alcohol ether sulfate, tallow fatty alcohol sulfate (25 ethylene oxide), tallow fatty ether sulfate, sodium dodecyl benzene sulfonate, sodium stearyl sulfate, sodium palmityl sulfate, sodium decyl sulfate, sodium myristyl sulfate, sodium dodecyl sulfate, potassium dodecyl benzene sulfonate, potassium stearyl sulfate, potassium palmityl sulfate, potassium decyl sulfate, potassium myristyl sulfate, potassium dodecyl sulfate, and mixtures thereof.

Other examples of permeation agents that may be used are sodium lauryl ether sulfate, ammonium lauryl sulfate, ammonium lauryl ether sulfate, sophorose biosurfactant, sodium lauroyl sarcosinate, triethanolamine lauroyl-L-glutamate, sodium myristyl sarcosinate, potassium laurate, sodium dodecane sulfonates, and sodium lauryl ethoxysulfate.

The amount of permeation agent in the compositions described herein may range from about 2 to about 10 percent by volume based on the total volume of the composition.

### Solubilzing Agents

Solubilzing agents may be included in the solvent to aid in solubilizing the components of the composition. Such solubilizing or dispersing agent may include, but are not limited to, alcohols, glycols, glycerines, and the like. The amount of solubilizing or dispersing agent in the compositions described herein may range from about 2 to about 10 percent by volume based on the total volume of the composition.

As set forth above, the primary solvent is an aqueous solvent, typically, water. However, water such as potable water may contain components that interfere with the effectiveness of the rinse and soak solutions.

The formulation may be in the form of a liquid, foam, aerosol, powder, mist, gel, film, solid, or spray.

### Wetting Agent

Wetting agent refers to a substance that increases the rate at which a liquid spreads across a surface, i.e., it renders a surface non repellent to a liquid. Examples of suitable wetting agents include, but are not limited to, TRITON® X-100 (generically, octylphenoxypolyethoxyethanol) (Sigma Chemical Co., St. Louis, Mo.), SEQUAWET® (generically, a nonionic dispersant) (Sequal Chemical Inc., Chester, S.C.), and AMWET® (generically, a wetting agent, detergent, penetrant for textile processing) (American Emulsions Co., Dalton, Ga.). Other wetting agents suitable for use in the present invention will be known to and used by those of skill in the art.

The wetting agent is typically present at a concentration ranging from about 0.1% to about 3% and, more preferably, at a concentration ranging from about 0.2% to about 1%.

Those of skill in the art will readily appreciate that the concentration of the various components of the aqueous treating solution can be widely varied depending upon the particular components employed and the results desired.

Furthermore, the present invention contemplates the use of additives to impart favorable characteristics to the cellulosic, cellulosic/polyester or polyester textile.

Such additives can include softeners and waterproofing agents which are known to and used by those of skill in the art. Examples of softeners which can be added to the aqueous treating solution include, but are not limited to, MYKON® and SEQUASOFT®, both of which are commercially available from Sequal Chemical Inc. (Chester, S.C.). Examples of waterproofing agents which can be added to the aqueous treating solution include, but are not limited to, SEQUAPEL® (Sequal Chemical Inc., Chester, S.C.), SCOTCHGARD (3M, St. Paul, Minn.) and other water repellent finishing solutions used by those of skill in the art.

In another embodiment, the protective apparel and/or equipment is impregnated with the rhamnolipid formulation after the object is finished.

In another embodiment, a coating layer is be sandwiched between layers of fabric.

Furthermore, the present invention provides a way for the consumer to determine when the effectiveness of the protective coating is lost. The present invention further include a color changing indicator in the formulation to indicate that the protective garment is being in contact with a chemical or biological hazard. It is required that the color changing indicator to be colorless and change color when in contact with the contamination.

The formulation may be in the form of a liquid, foam, aerosol, powder, mist, gel, solid, or spray.

The coating formulation of the present invention is applied directly into the object, the manufacture of the object (as in plastic, or synthetic, paper, or cloth protective suits) or added to traditional anti-microbial coating materials.

Suitable antimicrobial agents may be selected from, but are not limited to, halogenated hydroxyl ethers, acyloxydiphenyl ethers, halogenated 2-hydroxydiphenyl ether and/or a halogenated 2-acyloxy diphenyl ether, O-acyl derivatives, the esters of acetic acid, chloroacetic acid, methyl or dimethyl carbamic acid, benzoic acid, chlorobenzoic acid, methylsulfonic acid, chloromethylsulfonic acid, triclosan (manufactured by Ciba Geigy under the trade name Irgasan DP300 or Irgacare MP), or combinations thereof.

The coating composition is applied into the object in the form of foam, mist, aerosol, powder, or spray. In addition, the coating composition is mixed into the manufacture ingredients of the object.

Furthermore, the present invention relates the incorporation of rhamnolipids into articles including fabrics, bandages, gauze, wraps, and equipment to provide protection against life threatening hazards, such as chemicals agents, biological agents, and fire. In some embodiments, the fabrics having the rhamnolipids incorporated are used to produce garments with multiple hazard protection and superior heat dissipating properties. In other embodiments, the protective apparel and/or equipment is impregnated with the rhamnolipids formulation after the object is finished.

The commercially available fabrics include polyethylene fabrics such as DuPont's Tyvek®, polypropylene fabrics such as Kimberly-Clark's Kleenguard® or Kappler's Proshield®, plastic laminate fabrics such as DuPont's TyChem® or Kimberly Clark's HazardGard I®, microporous-film based fabrics such as DuPont's NexGen® or Kappler's Proshield 2®, carbon sphere composite fabrics such as Blucher GmbH's Saratoga™ and aramid fabrics such as DuPont's Kevlar® or Nomex®.

The coating formulation according to the present invention can also be applied to a broad range of other articles, including surgical hoods, hospital gowns, gloves, patient drapes, ponchos, partitions, coverings, jumpsuits, uniforms, fatigues, tents, envelopes, pouches, wallpaper, liners, drywall, house sidings, house foundations, radiation probes, etc.

What is claimed is:

1. A fire extinguishing formulation comprising:
0.01% to 35% volume of rhamnolipid; and
the balance being water as a carrier.
preferably 0.75% to 35% of rhamnolipid.

2. The fire extinguishing formulation of claim 1 having 0.75% to 35% of rhamnolipid.

3. The fire extinguishing formulation of claim 1 further comprising at least one colorant.

4. The formulation of claim 1 wherein the formulation is in the form of a liquid, foam, aerosol, powder, mist, gel, solid, or spray.

5. The fire extinguishing formulation of claim 1 wherein the formulation is incorporated into an existing fire extinguishing or retardant formulation.

6. A method for preventing, retarding, suppressing, and extinguishing fires comprising the steps of:
applying a sufficient amount of the fire extinguishing formulation of claim 1 to an area to be treated;
wherein the formulation is applied either before or after initiation of combustion.

7. A fire, biological, or chemical hazard coating formulation comprising:
0.01% to 65% of rhamnolipid;
0.01 to 3% of a wetting agent;
2 to about 10% of a permeation agent; and
the balance being water,
preferably 0.75% to 65% of rhamnolipid.

8. A method for coating an object with the formulation of claim 7, the method comprising the steps of:
a) applying a sufficient amount of the formulation of to the object to be treated;
b) optionally rubbing the formulation into the surface;
c) repeating steps a and b after a period of time.

9. The method of claim 8, wherein the surface is chosen from at least one of fibers, fabrics, films, non-woven fabrics, woven fabrics, yarn, knitted fabrics, garments, protective clothing, scrubs, coveralls, booties, face masks, gloves, apparel, linens, drapes, towels, laminates containing at least one fabric or film, sponges, mop heads, webs, bags, gauze, pads, wipes, pillows, bandages, or a combination thereof. In one desired embodiment of the present invention, the product comprises one or more pieces of protective garment, such as scrubs, coveralls, protective suits, booties, face masks, and gloves, bio-hazard suits, medical equipment, chemical laboratory equipment, food preparation equipment, daycare centers and hospital equipment and walls, military vehicles and equipment, bandages, gauze, wraps, and first aid appliances.

10. The method of claim 8 wherein the coating formulation is incorporated into the object during the manufacture of the object.

11. The method of claim 8 wherein the coating formulation is applied to the surface of the object.

12. The method of claim 8 wherein the coating formulation is impregnated into the object.

13. A chemical, fire, or biological hazard protective apparel comprising:
a garment for covering the wearer's body;
a continuous coating completely covering the garment
wherein the coating comprises a formulation comprising:
0.01% to 65% of rhamnolipid;
0.01 to 3% of a wetting agent;
2 to about 10% of a permeation agent; and
the balance being water.

14. The method according to claim 13, wherein the formulation is applied to the object by spray, mist, direct pour, gel, foam, or wiping the formulation into the surface.

15. The method according to claim 13, wherein the object is chosen from medical equipments, chemical testing equipments, food preparation equipments, daycare centers and hospital equipments, military vehicles and equipment, bandages, gauze, wrap, clothes, protective suits, protective gear, and other wound care equipment.
